(19) United States
(12) Patent Application Publication
(10) Pub. No.: US 2025/0356780 A1
(43) Pub. Date: Nov. 20, 2025

(54) MULTI-SCREEN ELECTRONIC SHELF LABEL

(71) Applicant: SHENZHEN MINEW TECHNOLOGIES CO LTD, Guangdong (CN)

(72) Inventor: Yan ZHUANG, Guangdong (CN)

(21) Appl. No.: 19/050,951

(22) Filed: Feb. 11, 2025

(30) Foreign Application Priority Data
May 15, 2024 (CN) 202421047278.X

(51) Int. Cl. G09F 3/20

(52) U.S. Cl. CPC G09F 3/208

(57) ABSTRACT

A multi-screen electronic shelf label, including a power supply, a plurality of screens, a master control chip, an antenna circuit, a screen driving circuit, and a RGB lamp circuit. The power supply is connected to the plurality of screens through the screen driving circuit, the power supply is connected to the master control chip, control ends of the screen driving circuit are respectively connected to control ends of the plurality of screens, each signal input of each of the plurality of screens is connected to a signal output of the master control chip, the master control chip is in communication connection with the antenna circuit, and an indication signal output of the master control chip is connected to a signal input of the RGB lamp circuit. The multi-screen electronic shelf label may display more information simultaneously to improve efficiency and flexibility of shelf management.

### CROSS-REFERENCE TO RELATED APPLICATION

This application claims priority to Chinese patent application No. 202421047278.X, filed on May 15, 2024, and entitled “multi-screen electronic shelf label”, the entire contents of which is incorporated herein by reference.

### TECHNICAL FIELD

The present disclosure relates to the field of label technologies, and more particularly, to a multi-screen electronic shelf label.

### BACKGROUND

In shelf management of a retail store, a shelf label is used to display information (e.g., a name and a price of a commodity). Traditional paper labels need to be replaced manually, the traditional paper labels are not only inefficient, but also are prone to cause errors. With the development of science and technology, electronic shelf labels are gradually popularized, display content may be updated in real time, and shelf management efficiency is greatly improved. However, most of the existing electronic shelf labels have a design of one single screen, display areas of these electronic shelf labels are limited, and display requirements of some large commodities or those commodities needing to display more information cannot be met.

### SUMMARY

In view of this, a main objective of the present disclosure is providing a multi-screen electronic shelf label.

In order to achieve the objective, the technical solutions of the present disclosure are implemented in this manner:

Embodiments of the embodiments of the utility model provides a multi-screen electronic shelf label, including a power supply, a plurality of screens, a master control chip, an antenna circuit, a screen driving circuit and a RGB lamp circuit. The power supply is connected to the plurality of screens through the screen driving circuit, the power supply is also connected to the master control chip. Control ends of the screen driving circuit are respectively connected to control ends of the plurality of screens, each signal input of each of the plurality of screens is connected to a signal output of the master control chip, the master control chip is in communication connection with the antenna circuit, and an indication signal output of the master control chip is connected to a signal input of the RGB lamp circuit.

In the aforesaid solution, the antenna circuit includes a second inductor, a third inductor, a first capacitor, a second capacitor, a third capacitor and an antenna. A first end of the second inductor is respectively connected to an ANT pin of the master control chip and a first end of the first capacitor, a second end of the second inductor is respectively connected to a first end of the third inductor and a first end of the second capacitor, a second end of the third inductor is respectively connected to a first end of the third capacitor and the antenna and thereby is grounded. A second end of the first capacitor, a second end of the second capacitor and a second end of the third capacitor are grounded.

In the aforesaid solution, a P0.07 pin of the master control chip is respectively connected to a SCK pin of each of the plurality of screens, a P0.08 pin of the master control chip is respectively connected to a SDI pin of each of the plurality of screens, a P0.05 pin of the master control chip is respectively connected to a SDO pin of each of the plurality of screens, and a P0.06 pin of the master control chip is respectively connected to a CS pin of each of the plurality of screens.

In the aforesaid solution, the screen driving circuit includes a first inductor, a first triode, a second triode, a fifth resistor, a sixth resistor, a seventh resistor, an eighth resistor, a fifth capacitor, a sixth capacitor, a tenth capacitor, a first diode, a second diode and a third diode. A drain electrode of the first triode is respectively connected to a first end of the fifth resistor, a first end of the fifth capacitor and the power supply, a source electrode of the first triode is connected to the power supply, a gate electrode of the first triode is respectively connected to a second end of the fifth resistor and the first end of the sixth resistor, a second end of the sixth resistor is connected to a P0.12 pin of the master control chip. The power supply is respectively connected to a first end of the first inductor and a first end of the ninth capacitor, a second end of the first inductor is respectively connected to a first end of the sixth capacitor, a negative electrode of the third diode and a source electrode of the second triode, a second end of the sixth capacitor is respectively connected to a negative electrode of the first diode and a positive electrode of the second diode, a negative electrode of the second diode is respectively connected to a PREVGL pin of each of the plurality of screens, a positive electrode of the third diode is respectively connected to a first end of the tenth capacitor and a PREVGH pin of each of the plurality of screens. A gate electrode of the second triode is respectively connected to a GDR pin of each of the plurality of screens and a first end of the seventh resistor, a second end of the seventh resistor is connected to a first end of the eighth resistor and thereby is grounded, a second end of the eighth resistor is respectively connected to a RESE pin of each of the plurality of screens and a drain electrode of the second triode. A second end of the fifth capacitor, a second end of the ninth capacitor, and a second end of the tenth capacitor are grounded.

In the aforesaid solution, the RGB lamp circuit includes a first light emitting diode, a second light emitting diode, a third light emitting diode, a fifteenth resistor, a sixteenth resistor and a seventeenth resistor. A negative electrode of the first light emitting diode is respectively connected to a negative electrode of the second light emitting diode, a negative electrode of the third light emitting diode and the power supply, a positive electrode of the first light emitting diode is connected in series with the fifteenth resistor and then is connected to a P0.18 pin of the master control chip. A positive electrode of the second light emitting diode is connected in series with the sixteenth resistor and then is connected to a P0.19 pin of the master control chip. A positive electrode of the third light emitting diode is connected in series with the seventeenth resistor and then is connected to a P0.17 pin of the master control chip.

As compared to the related art, the multi-screen electronic shelf label in the present disclosure has a plurality of screens, and may display more information simultaneously to improve the efficiency and the flexibility of shelf management. Moreover, Moreover, based on the functions of wireless communication and the RGB lamp circuit, convenient and diversified use of shelf labels are realized. In addition, the multi-screen electronic shelf label of the present disclosure has a simple structure, may be manufactured and maintained easily, and has a wide application prospect.

### DESCRIPTION OF THE DRAWINGS

The accompanying figures described herein are used to provide further interpretation of the present disclosure and constitute a part of the present disclosure, the schematic embodiments of the present disclosure and the explanations of the schematic embodiments are intended to explain the present disclosure, rather than being constituted as undeserved limitation to the present disclosure.

FIG. 1 illustrates a schematic structural diagram of the multi-screen electronic shelf label in accordance with one embodiment of the present disclosure;

FIG. 2 illustrates a schematic circuit configuration of the master control chip in accordance with one embodiment of the present disclosure;

FIG. 3 illustrates a schematic circuit configuration of the screen driving circuit in accordance with one embodiment of the present disclosure;

FIG. 4 illustrates a schematic circuit configuration of a first screen in accordance with one embodiment of the present disclosure;

FIG. 5 illustrates a schematic circuit configuration of a second screen in accordance with one embodiment of the present disclosure;

FIG. 6 illustrates a schematic circuit configuration of a third screen in accordance with one embodiment of the present disclosure;

FIG. 7 illustrates a schematic circuit configuration of a fourth screen in accordance with one embodiment of the present disclosure;

FIG. 8 illustrates a schematic circuit configuration of a n-th screen in accordance with one embodiment of the present disclosure;

FIG. 9 illustrates a schematic circuit configuration of the RGB lamp circuit in accordance with one embodiment of the present disclosure.

### DETAILED DESCRIPTION OF EMBODIMENTS

In order to make the objective, the technical solutions and the advantages of the present disclosure be clearer and more understandable, the present disclosure will be further described in detail below with reference to accompanying figures and embodiments. It should be understood that the embodiments described in detail herein are merely intended to illustrate but not to limit the present disclosure.

The same or similar reference numerals in the accompanying figures of the embodiments of the present disclosure correspond to the same or similar components. In the description of the present disclosure, it needs to be understood that, directions or location relationships represented by terms such as “up”, “down”, “left”, “right”, “inside”, “outside”, etc., are the directions or location relationships shown in the accompanying figures, and are only intended to describe the present disclosure conveniently and for the purpose of conciseness of description of the present disclosure, but should not be interpreted as indicating or implying that a device or a component indicated by the terms must have specific locations and be constructed and manipulated according to the specific locations. Therefore, these terms for describing the location relationships based on the accompanying figures are merely for exemplary illustration purposes, and cannot be interpreted as limitation to the present disclosure. A person of ordinary skill in the art may understand the specific meanings of these terms according to specific conditions.

It needs to be noted that, in the present disclosure, terms such as “comprising”, “including” or any other variation are intended to cover a non-exclusive inclusion, so that a process, a method, goods, or a device which includes a series of elements not only include the elements, but also include other elements that are not expressly listed, or include the elements inherent to such process, method, goods, or device. In the condition of no further limitations, an element which is defined by a sentence “includes one . . . ” does not exclude a presence of additional identical elements in the process, the method, the goods, and the device which include the elements.

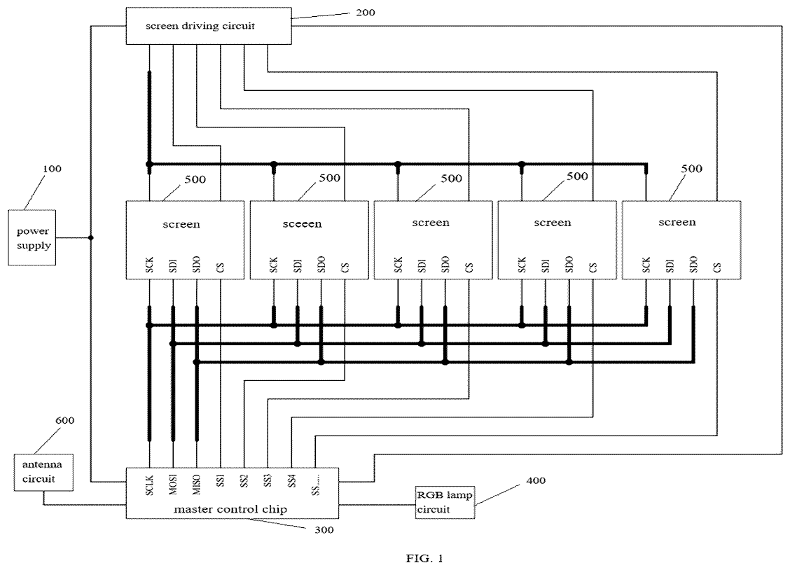

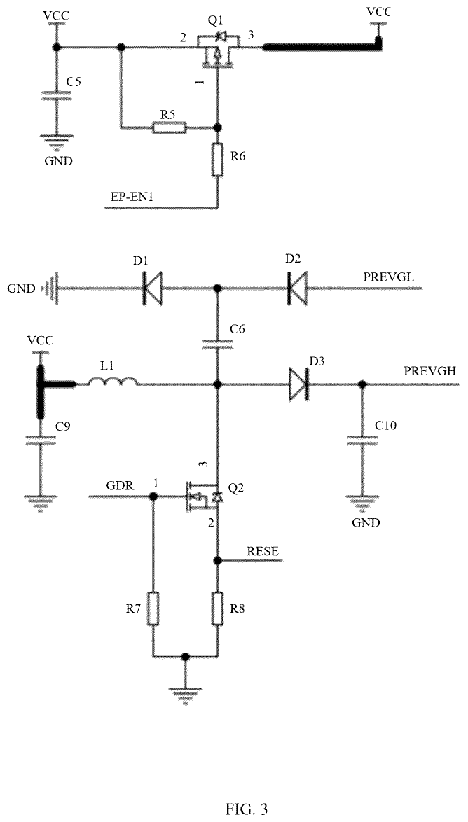

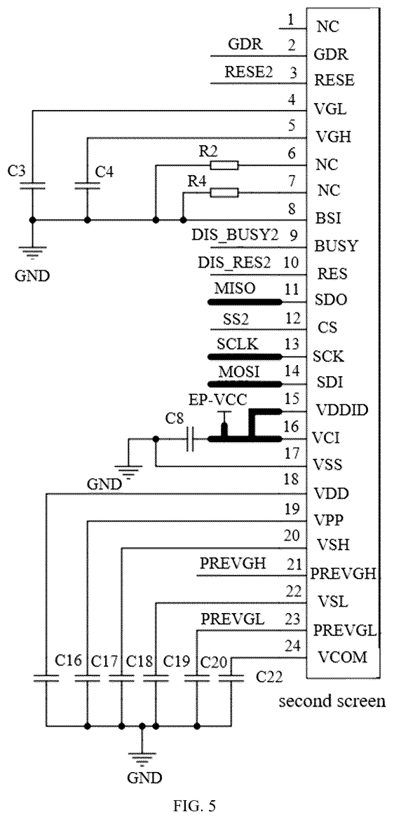

One embodiment of the present disclosure provides a multi-screen electronic shelf label. As shown in FIGS. 1-5, the multi-screen electronic shelf label includes a power supply 100, a plurality of screens, a master control chip 300, an antenna circuit 600, a screen driving circuit 200, and a red, green, blue (RGB) lamp circuit. The power supply 100 is connected to the plurality of screens 500 through the screen driving circuit 200. The power supply 100 is connected to the master control chip 300, and a control terminal of the screen driving circuit is connected to control terminals of the plurality of screens 500. Each signal input of each of the plurality of screens 500 is connected to a signal output of the master control chip 300. The master control chip 300 is connected in communication with the antenna circuit 600, and an indication signal output of the master control chip 300 is connected to a signal input of the RGB lamp circuit 400.

In the above circuit configuration, the power supply 100 provides power for the entire system, and is connected to the plurality of screens 500 and the master control chip 300 through the screen driving circuit 200. The screen driving circuit 200 is responsible for controlling display states of the plurality of screens 500, and the signal inputs of the plurality of screens 500 are connected to the signal output of the master control chip 300 to receive display contents sent from the master control chip 300. The master control chip 300 is a core of the entire system, the master control chip 300 not only controls the display contents of the plurality of screens 500, but also communicates with the outside through the antenna ANT1, and receives an updated instruction or data. In addition, the master control chip 300 is further provided with an indication signal output connected to the signal input of the RGB lamp circuit 400 and configured to control a display state of the RGB lamp circuit 400, thereby providing state indication or decoration effect for the shelf label.

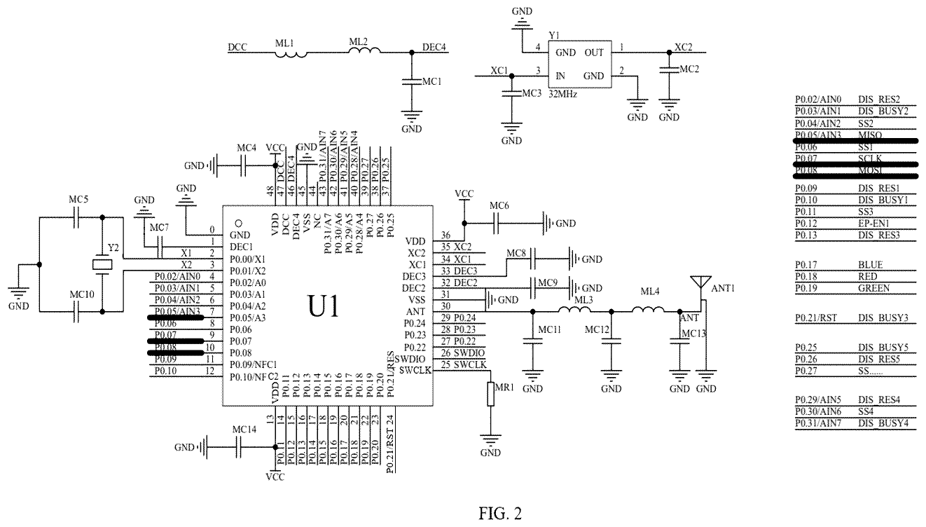

As shown in FIG. 2, the antenna circuit 600 includes a second inductor L2, a third inductor L3, a first capacitor C1, a second capacitor C2, a third capacitor C3, and an antenna ANT1. A first end of the second inductor L2 is respectively connected to an ANT terminal of the main control chip U1 and a first end of the first capacitor C1, a second end of the second inductor L2 is respectively connected to a first end of the third inductor L3 and a first end of the second capacitor C2, a second end of the third inductor L3 is respectively connected to a first end of the third capacitor C3 and the antenna ANT1 and thereby is grounded, a second end of the first capacitor C1, a second end of the second capacitor C2, and a second end of the third capacitor C3 are grounded.

In the aforesaid circuit configuration, the master control chip 300 is provided with a communication interface connected to the antenna and configured to receive and send a wireless signal, such that the multi-screen electronic shelf label may perform wireless communication with an external device or an external system, in order to implement functions such as remote updating and control

As shown in FIG. 1 to FIG. 3, a P0.07 pin of the master control chip 300 is respectively connected to a serial clock (SCK) pin of each of the plurality of screens 500, a P0.08 pin of the master control chip 300 is respectively connected to a serial digital interface (SDI) terminal of each of the plurality of screens 500, a P0.05 pin of the master control chip 300 is respectively connected to a serial data output (SDO) pin of each of the plurality of screens 500, and a P0.06 pin of the master control chip 300 is respectively connected to a chip selection (CS) pin of each of the plurality of screens 500.

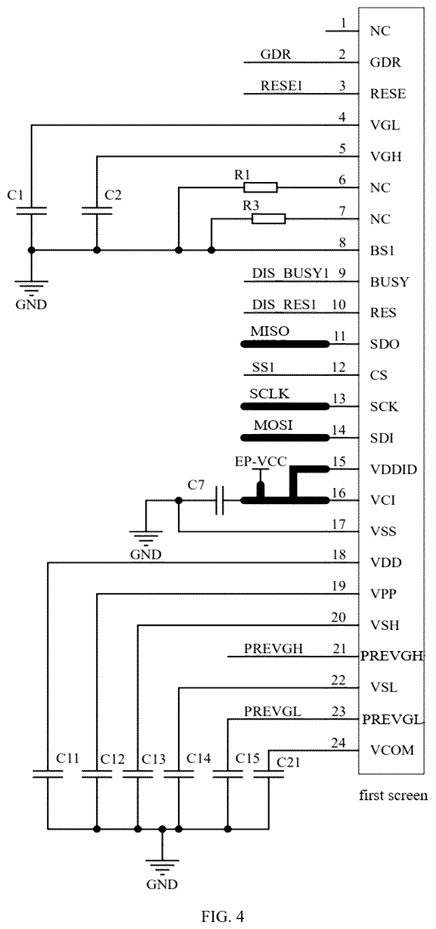

As shown in FIG. 1, FIG. 2 and FIG. 4, the screen driving circuit 200 includes a first inductor L1, a first triode Q1, a second triode Q2, a fifth resistor R5, a sixth resistor R6, a seventh resistor R7, an eighth resistor R8, a fifth capacitor C5, a sixth capacitor C6, a tenth capacitor C10, a first diode D1, a second diode D2, and a third diode D3. A drain electrode of the first triode Q1 is respectively connected to a first end of the fifth resistor R5, a first end of the fifth capacitor C5, and the power supply 100. A source electrode of the first triode Q1 is connected to the power supply 100. A gate electrode of the first triode Q1 is respectively connected to a second end of the fifth resistor R5 and a first end of the sixth resistor R6, and a second end of the sixth resistor R6 is connected to a P0.12 pin of the main control chip U1. The power supply 100 is respectively connected to a first end of the first inductor L1 and a first end of the ninth capacitor C9, a second end of the first inductor L1 is respectively connected to a first end of the sixth capacitor C6, a negative electrode of the third diode D3, and a source electrode of the second triode Q2. A second end of the sixth capacitor C6 is respectively connected to a negative electrode of the first diode D1 and a positive electrode of the second diode D2, and a negative electrode of the second diode D2 is respectively connected to a pre ground voltage low (PREVGL) pin of each of the plurality of screens 500. A positive electrode of the third diode D3 is respectively connected to a first end of the tenth capacitor C10 and a pre gate voltage high (PREVGH) pin of each of the plurality of screens 500. A gate electrode of the second triode Q2 is respectively connected to a GDR pin of each of the plurality of screens 500 and a first end of the seventh resistor R7, a second end of the seventh resistor R7 is connected to a first end of the eighth resistor R8 and thereby is grounded, a second end of the eighth resistor R8 is respectively connected to a RESE pin of each of the plurality of screens 500 and a drain electrode of the second triode Q2. A second end of the fifth capacitor C5, a second end of the ninth capacitor C9, and a second end of the tenth capacitor C10 are grounded.

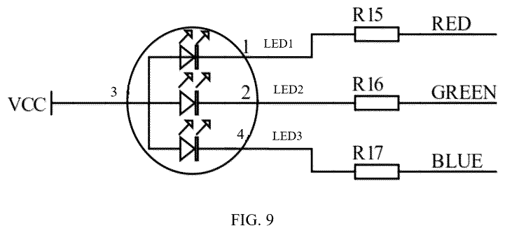

As shown in FIG. 2 and FIG. 9, the RGB lamp circuit 400 includes a first light emitting diode LED1, a second light emitting diode LED2, a third light emitting diode LED3, a fifteenth resistor R15, a sixteenth resistor R16, and a seventeenth resistor R17. A negative electrode of the first light emitting diode LED1 is connected to a negative electrode of the second light emitting diode LED2, a negative electrode of the third light emitting diode LED3, and the power supply 100. A positive electrode of the first light emitting diode LED1 is connected in series with the fifteenth resistor R15 and then is connected to a P0.18 pin of the main control chip U1. A positive electrode of the second light emitting diode LED2 is connected in series with the sixteenth resistor R16 and then is connected to a P0.19 pin of the main control chip U1. A positive electrode of the third light emitting diode LED3 is connected in series with the seventeenth resistor R17 and then is connected to a P0.17 pin of the main control chip U1.

In the above circuit configuration, the master control chip 300 is provided with a RGB control terminal configured to send an indication signal to the RGB lamp circuit 400. The RGB lamp circuit 400 may display different colors or enter a flicker mode according to different indication signals, and provide a status indication (e.g., insufficient power, data updating), or a decoration effect for the shelf label.

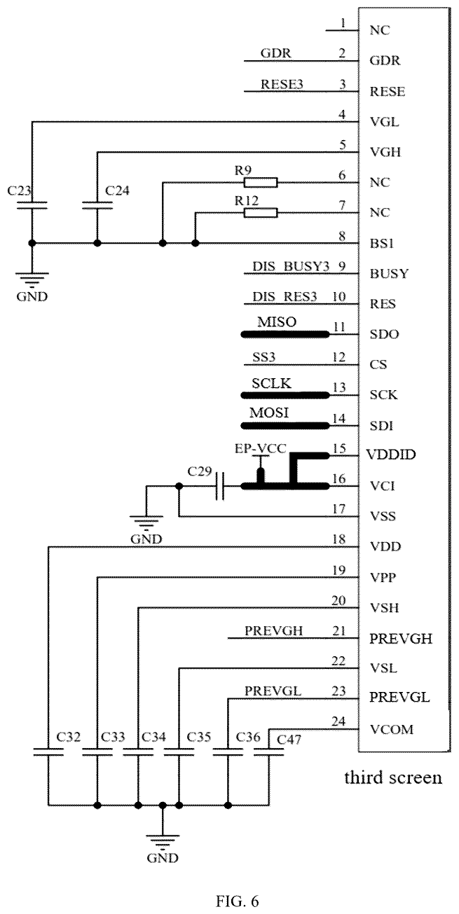

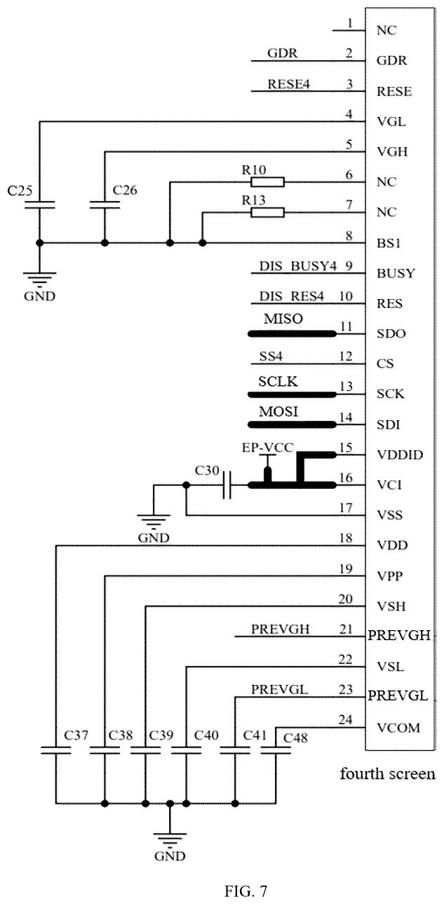

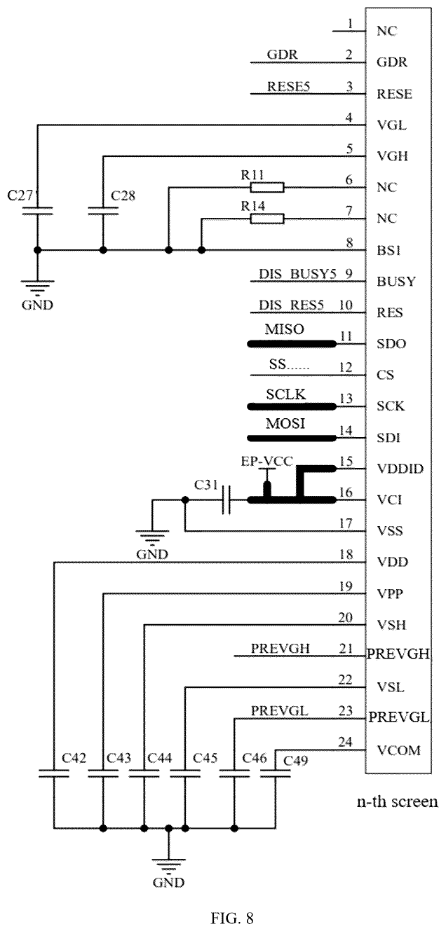

In practical application, the plurality of screens 500 (as shown in FIGS. 4-8) of the multi-screen electronic shelf label may respectively display different information, such as commodity name, price, promotion information, and the like. According to cooperation of the plurality of screens 500, the efficiency and the flexibility of shelf management may be greatly improved. Moreover, due to the adoption of the functions of the wireless communication and the RGB lamp circuit 400, the use of the shelf label is more convenient and more diversified.

In conclusion, the present disclosure uses horizontal splicing of small-sized screens 500 to achieve the purpose of displaying more contents. The display area may be increased while a longitudinal size of the product (the multi-screen electronic shelf label) is kept unchanged according to reasonable splicing design. This design enables labels to be conveniently mounted on the original shelf guide rail without modifying the design of the shelf. A same display effect of large screen may be achieved by splicing a plurality of small screens 500, while the cost is reduced. This enables the multi-screen electronic shelf label of the present disclosure to have competitive advantages over prices, and is prone to popularize in the market. The plurality of screens 500 (as shown in FIGS. 4-8) share one master control circuit and some drive circuits, which simplifies system structure and reduces power consumption. When information updating needs to be performed, these small screens 500 update images sequentially, and has a lower power consumption as compared to one single large screen. Thus, a small battery may be used to drive the multi-screen electronic shelf label, and a service time of the label is prolonged. Splicing intervals among these screens 500 has a visual isolation function, thus, information of different commodities is clearer and may be distinguished more easily. Moreover, the wireless communication function of the multi-screen electronic shelf label enables the information update to be more convenient and faster, and improves the efficiency of shelf management.

The foregoing descriptions are only some preferable embodiments of the present disclosure and are not intended to limit the protection scope of the present disclosure.

1. A multi-screen electronic shelf label, comprising a power supply, a plurality of screens, a master control chip, an antenna circuit, a screen driving circuit and a RGB lamp circuit, wherein the power supply is connected to the plurality of screens through the screen driving circuit, the power supply is also connected to the master control chip, control ends of the screen driving circuit are respectively connected to control ends of the plurality of screens, each signal input of each of the plurality of screens is connected to a signal output of the master control chip, the master control chip is in communication connection with the antenna circuit, and an indication signal output of the master control chip is connected to a signal input of the RGB lamp circuit.

2. The multi-screen electronic shelf label according to claim 1, wherein the antenna circuit comprises a second inductor, a third inductor, a first capacitor, a second capacitor, a third capacitor and an antenna, wherein a first end of the second inductor is respectively connected to an ANT pin of the master control chip and a first end of the first capacitor, a second end of the second inductor is respectively connected to a first end of the third inductor and a first end of the second capacitor, a second end of the third inductor is respectively connected to a first end of the third capacitor and the antenna and thereby is grounded; a second end of the first capacitor, a second end of the second capacitor and a second end of the third capacitor are grounded.

3. The multi-screen electronic shelf label according to claim 2, wherein a P0.07 pin of the master control chip is respectively connected to a serial clock (SCK) pin of each of the plurality of screens, a P0.08 pin of the master control chip is respectively connected to a serial digital interface (SDI) pin of each of the plurality of screens, a P0.05 pin of the master control chip is respectively connected to a serial data output (SDO) pin of each of the plurality of screens, and a P0.06 pin of the master control chip is respectively connected to a chip selection (CS) pin of each of the plurality of screens.

4. The multi-screen electronic shelf label according to claim 3, wherein the screen driving circuit comprises a first inductor, a first triode, a second triode, a fifth resistor, a sixth resistor, a seventh resistor, an eighth resistor, a fifth capacitor, a sixth capacitor, a tenth capacitor, a first diode, a second diode and a third diode, wherein a drain electrode of the first triode is respectively connected to a first end of the fifth resistor, a first end of the fifth capacitor and the power supply, a source electrode of the first triode is connected to the power supply, a gate electrode of the first triode is respectively connected to a second end of the fifth resistor and the first end of the sixth resistor, a second end of the sixth resistor is connected to a P0.12 pin of the master control chip, the power supply is respectively connected to a first end of the first inductor and a first end of a ninth capacitor, a second end of the first inductor is respectively connected to a first end of the sixth capacitor, a negative electrode of the third diode and a source electrode of the second triode, a second end of the sixth capacitor is respectively connected to a negative electrode of the first diode and a positive electrode of the second diode, a negative electrode of the second diode is respectively connected to a PREVGL pin of each of the plurality of screens, a positive electrode of the third diode is respectively connected to a first end of the tenth capacitor and a PREVGH pin of each of the plurality of screens; a gate electrode of the second triode is respectively connected to a GDR pin of each of the plurality of screens and a first end of the seventh resistor, a second end of the seventh resistor is connected to a first end of the eighth resistor and thereby is grounded, a second end of the eighth resistor is respectively connected to a RESE pin of each of the plurality of screens and a drain electrode of the second triode, a second end of the fifth capacitor, a second end of the ninth capacitor, and a second end of the tenth capacitor are grounded.

5. The multi-screen electronic shelf label according to claim 4, wherein the RGB lamp circuit comprises a first light emitting diode, a second light emitting diode, a third light emitting diode, a fifteenth resistor, a sixteenth resistor and a seventeenth resistor, wherein a negative electrode of the first light emitting diode is respectively connected to a negative electrode of the second light emitting diode, a negative electrode of the third light emitting diode and the power supply, a positive electrode of the first light emitting diode is connected in series with the fifteenth resistor and then is connected to a P0.18 pin of the master control chip, a positive electrode of the second light emitting diode is connected in series with the sixteenth resistor and then is connected to a P0.19 pin of the master control chip, and a positive electrode of the third light emitting diode is connected in series with the seventeenth resistor and then is connected to a P0.17 pin of the master control chip.
